(19) United States
(12) Patent Application Publication
(10) Pub. No.: US 2009/0314585 A1
(43) Pub. Date: Dec. 24, 2009

(54) SUSPENSION AND TRACTION ELEMENT FOR ELEVATOR APPARATUSES AND ELEVATOR APPARATUS

(75) Inventors: Inaki Aranburu Agirre, Guipuzcoa (ES); Miguel Encabo Elizondo, Guipuzcoa (ES); Miguel Angel Madoz Michaus, Guipuzcoa (ES)

Correspondence Address: CANTOR COLBURN, LLP, 20 Church Street, 22nd Floor, Hartford, CT, 06103, US

(73) Assignee: ORONA S. COOP., Hernani (guipuzcoa) (ES)

(21) Appl. No.: 12/442,912

(22) PCT Filed: Sep. 24, 2007
(86) PCT No.: PCT/ES2007/000542

§ 371 Date: Mar. 25, 2009

(30) Foreign Application Priority Data
Sep. 25, 2006 (ES) P200602425

(51) Int. Cl. B66B 7/06; B66B 11/08

(52) U.S. Cl. 187/266; 187/251

(57) ABSTRACT

The invention relates to a suspension and traction element (1, 1′, 1″) incorporating two parts. A first part (2) is formed by at least one coated rope (3) or at least one coated belt (20) covered with thermoplastic material, forming a traction and contact sector on the traction sheave (10) and on the deflector sheaves (13, 14), and having connecting parts (4, 4′) on which the respective ends of the coated ropes (3) or coated belts (20) are fixed and clustered. It also has at least one second part (5) forming a support sector which does not contact with the traction sheave (10) or with the deflector sheaves (13, 14).

### FIELD OF THE INVENTION

The present invention is comprised in the field of elevator apparatuses, specifically focusing on the elements for the support and traction of the car and the counterweight.

### BACKGROUND OF THE INVENTION

The suspension and traction elements for elevator apparatuses conventionally consist of wire ropes with a nominal diameter starting from 8 mm, formed by a central core on which several strands are twisted, each of which is in turn formed by several steel wires twisted around a core wire. The central core can also be formed by a wire strand of the type such as the aforementioned or it can be formed by a synthetic material.

The regulations in force on elevator apparatuses, in relation to the rules for building and installing elevators (UNE-EN 81), provides that the ratio between the pitch diameter D_{P} of the traction sheave or of the guide sheaves and the nominal diameter d_{N} of the suspension ropes must be D_{P}/d_{N}≧40.

As a result of this regulation, in order to comply with said ratio and considering that the minimum nominal diameter of conventional ropes is d_{N}=8 mm, a traction or guide sheave of at least D_{P}=320 mm in diameter must be used.

Recent advances in the field of elevator apparatuses have been focused on reducing the necessary space occupied by elevator drive units, which tend to be located inside the shaft, preferably in the upper part thereof. One of the limitations to reducing the dimensions of drive units is determined by the diameter of the traction sheave.

A reduction in the diameter of the sheave also implies a decrease in energy consumption. If the diameter of the traction sheave is to be reduced maintaining the D_{P}/d_{N}≧40 ratio the diameter of the suspension and traction rope must be reduced.

New inventions have recently come about in which the diameter of the traction sheave is reduced maintaining the D_{P}/d_{N}>40 ratio. This is achieved with the development of new suspension ropes which allow assuring the same traction capacity and even exceeding it, optimizing the remaining characteristics of traditional ropes such as fatigue, bending strength, service life, elimination of maintenance, etc.

These ropes share two features distinguishing them from conventional ropes. The first is that they are formed by very high-strength steel wires of a very small diameter, whereby the nominal diameter of the rope can be reduced, favoring bending strength and fatigue strength and increasing the service life. The second feature is that the strands and/or the rope are coated with a non-metallic material, usually thermoplastic or elastomeric material, such as for example, polyurethane, rubber, etc . . . , this feature increases the traction capacity since the coefficient of friction between the sheave and the rope, and therefore the grip, further prevents abrasion and wear of both the rope and the sheave. Other advantages associated to the coating are that it allows using sheaves with less aggressive, preferably semicircular grooves. The use of this type of groove extends the life of the rope since the pressure between rope and sheave is distributed more uniformly than with other geometries, and concentrated pressure areas which may damage the rope after a small number of trips of the car between floors do not occur. This is unlike conventional ropes which have sheaves with aggressive grooves, for example, notched semicircular grooves or V-grooves, which will sustain more wear, making it necessary to regularly perform inspection and maintenance tasks to assure the traction capacity of the system and therefore the replacement thereof due to excessive levels of wear.

The incorporation of this coating also prevents the inner lubricant of the rope, if it has any, from coming out of the rope, and therefore it does not require being lubricated during its lifetime, being unnecessary to perform maintenance tasks. On the other hand, since the lubricant does not come out, the rope is not a source of dirt for the rest of the installation, unlike what occurs with conventional ropes.

These types of ropes are currently found in a possible embodiment as coated circular ropes, whereas in another possible embodiment they take on the form of flat belts or ropes formed by several strands separated a distance that are coated, giving rise to the belt.

An example of the first type of rope is found in patent WO 2004/076327, which describes a rope formed by a core strand over which several outer strands are twisted, each of the strands being formed by high-strength steel filaments with a very small diameter, the rope being coated with thermoplastic material.

On the other hand, patent EP1273695 describes a rope formed by several strands, each of which is covered with resin and all of the strands are equally covered with resin, thus contributing to reducing wear of the rope in contact with the sheave.

Another type of tension member for an elevator is described in patent WO-99/43885, which consists of a belt made up of a series of ropes arranged on one and the same plane encased within a layer of coating.

This type of rope is used in the known state of the art instead of conventional ropes.

One of the problems of the previously mentioned ropes is that their cost is higher than that of conventional ropes, which increases the cost of the elevator apparatus incorporating them. In the case of flat ropes or belts, the cost increase is further accentuated since the necessary rope fastenings are more complicated and expensive.

On the other hand, the assembly of this type of rope is complicated and hindered by the excess gripping between the rope and the sheaves, since once a first rope is assembled, the coefficient of friction between this first rope and the sheaves through which it passes is enough for such sheaves to not rotate freely when a second and successive ropes are assembled.

On the other hand, alternative solutions are known in which the suspension elements are independent of the traction elements, i.e., the car and the counterweight are suspended by ropes carrying most of the load, whereas the transmission of movement and therefore the traction are performed by means of another type of rope, such as coated circular ropes or belts providing greater traction capacity.

Patent FR-2813874 describes an elevator apparatus of this type in which the car and the counterweight are supported by suspension ropes consisting of conventional steel ropes, whereas the movement and therefore the traction of the system are performed by means of other ropes consisting of traction ropes.

It is known in the field of the art comprising the present invention that any optimization of the suspension and traction elements in relation to reducing their cost, making their assembly and maintenance less complicated or minimizing the space necessary for the traction, is a technological advance.

### DESCRIPTION OF THE INVENTION

To solve the problems described above the present invention proposes a suspension and traction element for elevator apparatuses, preferably electric-type passenger elevators with a counterweight, which allows obtaining a cost reduction, making the assembly and maintenance operations less complicated, simplifying the components and/or reducing the number of the latter.

This suspension and traction element allows supporting the car of an elevator with its load and the counterweight, and it is also able to transmit power from the drive unit, usually an electric traction machine provided with a sheave, to these two moving masses providing sufficient traction capacity by friction on the sheave.

This suspension and traction element is formed by two parts each of which is optimized to perform a different function and fulfill different requirements. These two parts can be connected directly to one another or having the placement of an intermediate part.

The first part of length L1 has the function of providing traction capacity between the drive unit and the car and the counterweight, in addition to the function of supporting the load, whereas the second part of length L2 has the basic function of supporting the car and the counterweight, as well as adjusting the total length L of the suspension and traction element to the actual required length of the elevator apparatus, which does not usually correspond to the theoretical value calculated in the factory depending on the dimensions of the shaft reflected by the construction plans of the building, such that the sum of the length of the two parts, L1 and L2, is equal to the total length L of the suspension and traction element.

The first part intended for the traction of the moving masses has a partial length L1 with respect to the total length of the complete suspension and traction element L, enough to assure that during the entire travel of both the car of the elevator apparatus and the counterweight, all the sheaves of the installation contact exclusively with said first part. However, the function of the second part of length L2 is to support and adjust the rest of the length of the suspension and traction element to the fixing ends of said element, without contacting with any sheave of the installation, whether it is the traction sheave of the drive or any other guide sheave.

In a preferred embodiment the first part is formed by at least one coated rope or by at least one coated belt covered with thermoplastic material and by several connecting parts which are secured to the respective ends of said coated individual rope or coated individual belt.

The first part is preferably formed by at least two ropes of the type which are formed by strands of high mechanical strength steel wires which are twisted around a core wire and coated with a non-metallic material, preferably thermoplastic material, e.g. polyurethane. These coated ropes are integral with one another at their ends by means of preferably rigid connecting parts, forming a bundle of individual ropes that is pre-assembled with said connecting parts in the factory, thus assuring uniformity in the length of all the coated ropes that form it and therefore uniformity in the load that each individual rope carries.

Another embodiment of the invention contemplates that the set of coated ropes of the first part is assembled on site with conventional rope fastenings to the connecting part by an assembly technician.

The second part connected immediately to the first part is formed by a single conventional circular rope the breaking load is equivalent to the sum of the breaking loads of the individual ropes forming the first part. Since this second part does not pass through any sheave, it will not sustain abrasion, wear and/or bending fatigue and evidently does not require providing traction capacity, therefore it will not be dimensioned for this service.

The ends of the second part are fixed by means of conventional rope fastenings, using a first rope fastening at one end to form the connection with a fixed point of the installation, and a second rope fastening at the other end which is connected to the intermediate part and the latter in turn to the first part through the connecting part of the coated individual ropes. The cost of the second part is much lower than that of the first part.

The intermediate part connecting the two parts of the suspension and traction element allows connecting or is adapted to connect any type of conventional rope fastening to the connecting part of the first part. Furthermore the intermediate part can allow the axial rotation of the first part with respect to the second part about the longitudinal axis of the suspension and traction element.

Another aspect of the invention relates to the actual connecting part the functions of which are, on one hand, integrally connecting the ends of all the coated individual ropes of the first part, and on the other hand connecting the first part to the intermediate part in one case and forming a connection with a fixed point of the installation in the other case. This part is designed to endure at least 80% of the breaking load of both the first part and the second part. In no case will this rigid part pass through any sheave of the installation and it can be carried out by means of different industrial manufacturing techniques.

The force necessary to extract the ropes from this connecting part will be at least 80% of the sum of the breaking loads of the coated ropes of the first part:

Fextr>0.80*n*CRind, where:

Fextr: Force to extract the ropes from the rigid part.

n: Number of individual ropes forming the first part.

CRind: Minimum breaking load of a rope of the first part.

For example, for a first part formed by 8 wire ropes with diameter 2.5 mm, the minimum breaking load of which is 6,500 N and which are coated with polymer material, it will be necessary to apply a minimum force of 0.80*8*6,500=41,600 N to separate the ropes from the connecting part.

Another advantage of the invention relates to the decrease in the total number of rope fastenings needed for an elevator apparatus incorporating one or several suspension and traction elements according to the invention compared to the conventional apparatuses in which two rope fastenings for each rope are needed.

On the other hand, in the case of flat ropes, an advantage of the invention is that it eliminates complex rope fastenings necessary for this type of ropes, using only conventional rope fastenings in addition to the mentioned connecting part to make the ends of the individual ropes of the first part integral with the intermediate part connecting the first part with the second part.

The incorporation of the present suspension and traction element thus achieves reducing the total cost of the installation.

Another advantage of the invention consists of assuring a uniform distribution of the load among the individual ropes, unlike what occurs with the ropes of a conventional elevator apparatus which require means at their ends which allow regulating and uniformly distributing the load among them.

Another object of the invention relates to the elevator apparatus incorporating at least one suspension and traction element according to the previous description.

Another advantage of the invention is that it can be applied for any type of suspension system. In a first type of configuration, which has traditionally been the most widely used, called “1:1 suspension”, the traction machine is located somewhere in the structure, either at the top or bottom of the elevator shaft, and the car and the counterweight of the elevator are held either directly or through deflector sheaves.

Another widely extended configuration is the “2:1 suspension” in which, like the previous case, the traction machine is located at the top of the elevator shaft or at any point thereof and the car and the counterweight of the elevator are supported through deflector sheaves traveling with these elements. In this case the speed of the suspension elements is twice the speed of linear travel of the car and the counterweight, but the traction load in the suspension elements is half that.

Other configurations are obvious in view of this description, the scope of the invention extending to any suspension ratio (n:m), applicable to elevators with or without an engine room.

Similarly, it is considered that the conventional ropes of the second part can generally be replaced with any elongated, rigid and/or flexible equivalent support element, the function of which is the same, i.e., to support the load and adapt the length of the suspension and traction element to the length actually required by the installation. This elongated element can consist of a strap, sling, belt, rod, etc, duly fixed at one end to the intermediate part and at the other end to a fixed point of the installation.

The coated individual ropes forming the first part L1 are formed by very high-strength steel wires between 2,000 and 4,000 N/mm², whereby the nominal diameter of the coated rope can be reduced to a range between 1 and 5 mm, favoring the bending strength, fatigue strength and service life. The strands and/or the rope are coated with a non-metallic material, usually thermoplastic or elastomeric material, such as for example, polyurethane, rubber, etc . . . which partially or completely penetrates between the strands and provides a slightly thick outer layer.

Coated circular ropes, as well as coated belts formed by several strands separated a distance can therefore be used, or other types of ropes, such as for example synthetic coated ropes of the type using aramid fibers, Kevlar, etc., which are clustered together forming at least one strand coated with thermoplastic or elastomeric material, as well as other alternative solutions, can also be used.

The use of both coated flat belts and of coated individual clusters in the first part involves the use of sheaves with a flat, convex or concave surface, and even with ribs for shaped belts.

The described suspension element is incorporated in conventional elevator apparatuses generally having a traction sheave, a car, a counterweight and optionally deflector sheaves.

The traction sheave is provided with groups of grooves with pitch diameter D_{P}≦150 mm in a number coinciding with the number of coated ropes of the first part of each suspension and traction element.

These grooves are preferably semicircular, the geometry has a diameter d_{G}, meeting the following:

d≦d_{G}≦1.5d

where d is the diameter of the coated rope and d_{G} the diameter of the geometric profile of each groove of the traction sheave and

10°≦α≦75°

where α is the angle of the geometric profile of each groove of the traction sheave.

Preferably 1.05 d≦d_{G}≦1.3 d and 25°≦α≦45°.

The guide sheaves are also provided with groups of grooves coinciding in number with the number of suspension and traction elements, which are clustered in respective freely rotating and independent discs with pitch diameter D_{P}≦150 mm, each of the groups being formed by a number of grooves coinciding with the number of coated ropes of the first part of the suspension and traction element. These grooves are semicircular, the geometry of which has a diameter d_{G} meeting the following:

d≦d_{G}≦1.5d

where d is the diameter of the coated rope and d_{G} the diameter of the geometric profile of each groove of the guide sheave and

10°≦α≦75°

where α is the angle of the geometric profile of each groove of the sheave.

Preferably 1.05 d≦d_{G}≦1.3 d, and 25°≦α≦45°

### BRIEF DESCRIPTION OF THE FIGURES

To complement the description being made and for the purpose of aiding to better understand the features of the invention according to a preferred practical embodiment thereof a set of drawings is attached as an integral part of said description in which the following has been depicted in an illustrative and non-limiting manner:

FIG. 1 shows the depiction of a set of 5 conventional ropes forming a suspension and traction element for elevator apparatuses according to a solution belonging to the state of the art.

FIG. 2a shows an embodiment according to the invention in which the suspension and traction element is formed by two parts, in which the second part comprises two end sections having equal features, showing a single fastening at each of the ends of the suspension and traction element.

FIG. 2b shows another embodiment of the suspension and traction element.

FIG. 3 shows an alternative to the embodiment depicted in FIG. 2a in which the ends of the individual ropes of the first part are connected by means of conventional rope fastenings directly to the connecting part.

FIG. 4a shows an elevator apparatus with a 1:1 suspension ratio incorporating the suspension and traction element.

FIG. 4b shows an elevator apparatus with a 2:1 suspension ratio incorporating the suspension and traction element.

FIGS. 5a, 5b, 5c, 5d, 5e, 5f and 5g show the section of different coated individual ropes and coated belts which can be assembled in the first part of the suspension and traction element.

FIG. 6a shows an example of the geometry of the grooves of the traction sheave of an elevator apparatus adapted to incorporate two suspension and traction elements.

FIG. 6b shows a section view of the guide sheave of the elevator apparatus adapted to incorporate two suspension and traction elements.

FIG. 7 shows an embodiment of the intermediate part allowing the rotation of the first part with respect to the second part.

### DETAILED DESCRIPTION OF THE PREFERRED EMBODIMENTS

A series of preferred embodiments of the invention are described below in reference to the drawings.

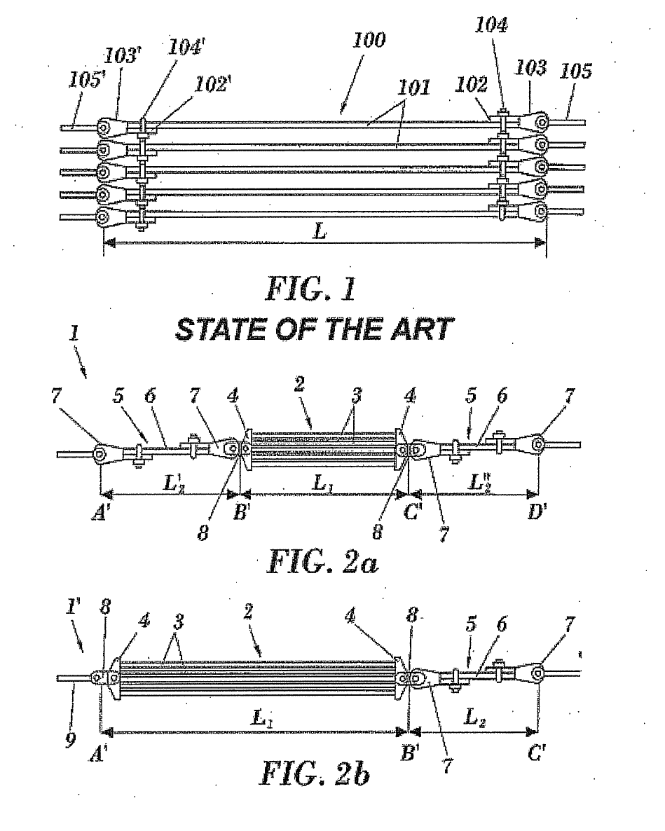

First, FIG. 1 shows a conventional suspension and traction element (100) for elevator apparatuses according to a solution belonging to the state of the art, showing that it has total length L and is formed by 5 conventional ropes (101) of the same length, each of the ends thereof (102, 102′) having a rope clamp or clip (104, 104′) and a rope fastening (103, 103′) associating each conventional rope (101) to a rod (105, 105′) fixing the suspension and traction element (100) to the end points of the elevator apparatus or of the installation.

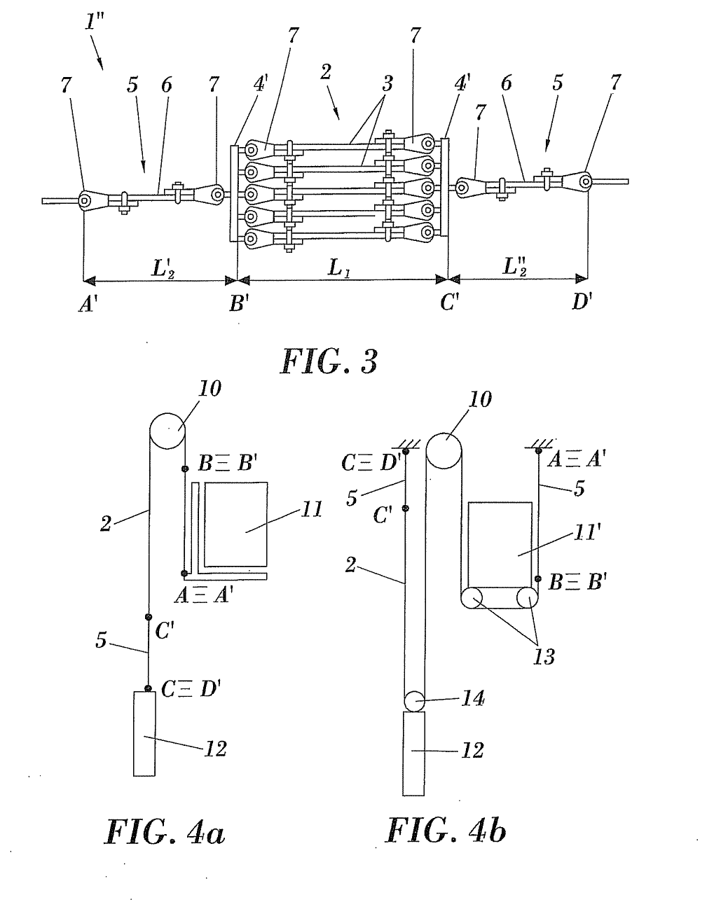

The suspension and traction element (1, 1′, 1″) for elevator apparatuses forming the object of this invention generally comprises:
a first part (2), formed by at least one coated rope (3), as depicted in FIGS. 2a, 2b or 3, or at least one coated belt (20), covered with thermoplastic material, forming a 20 contact and/or traction sector of the suspension and traction element (1, 1′, 1″) on the traction sheave (10) and on the deflector sheaves (13, 14), and by connecting parts (4, 4′) on which the ends of the coated ropes (3) or coated belts (20) are fixed and clustered,
at least one second part (5) associated to at least one of the connecting parts (4, 4′) consisting of an elongated support element which does not contact with the traction sheave (10) or with the deflector sheaves (13, 14), and
optionally at least one intermediate part (8) connecting the second part (5) with the connecting parts (4, 4′) of the first part (2).

FIG. 2a shows one of the preferred embodiments of the suspension and traction element (1) according to the invention being described, which shows a first part (2) of length L1 formed by 5 coated ropes (3) secured at their respective ends by means of preferably rigid connecting parts (4), and a second part (5) formed by two sections of length L2′ and L2″, each of them formed by a single rope (6) and respective rope fastenings (7) at their ends, which are connected to the connecting parts (4) of the first part (2) by means of the intermediate part (8). The total length of the suspension and traction element (1) is the sum of L1, L2′ and L2″ and is equivalent to the length L of the conventional suspension and traction element (100) depicted in FIG. 1.

The rope (6) of the second part (5) has a breaking strength equivalent to the sum of the breaking strengths of the coated ropes (3) of the first part (2).

FIG. 2b shows another preferred embodiment of the suspension and traction element (1′) of the invention in which the first part (2) is fixed to an end point of the elevator apparatus or of the installation by means of the connecting part (4), the intermediate part (8) and a rod (9), whereas at the other end of the first part (2) the other connecting part (4) is connected to the rope fastenings (7) of the second part (5) in which the rope (6) is located, by means of an intermediate part (8). In this case the sum of length L1 of the first part (2) and the length L2 of the second part (5) gives rise to the same length L of the conventional suspension and traction element (100) depicted in FIG. 1.

FIG. 3 shows an embodiment alternative of the suspension and traction element (1″) in which the coated ropes (3) corresponding to the first part (2) are connected at each of their ends to the connecting part (4′) by means of rope fastenings (7), said connection being able to be made directly on site. The remaining components are similar to the example described in FIG. 2a.

FIGS. 4a and 4b show two examples of elevator apparatuses incorporating a suspension and traction element (1, 1′, 1″) according to the invention, showing end points A, A′, C, D′ of the suspension and traction element (1, 1′, 1″) also shown in FIGS. 2a, 2b and 3, as well as connecting points B, B′, C′ between the two parts (2, 5) forming the suspension and traction element (1, 1′, 1″).

FIG. 4a shows an elevator apparatus comprising a traction sheave (10) transmitting the rotational movement of the motor and transforming it into vertical travel of the car (11) and of the counterweight (12). FIG. 4b shows another elevator configuration in which the traction sheave (10) transmits movement to the car (11′) and to the counterweight (12) by means of the guide sheaves (13, 14).

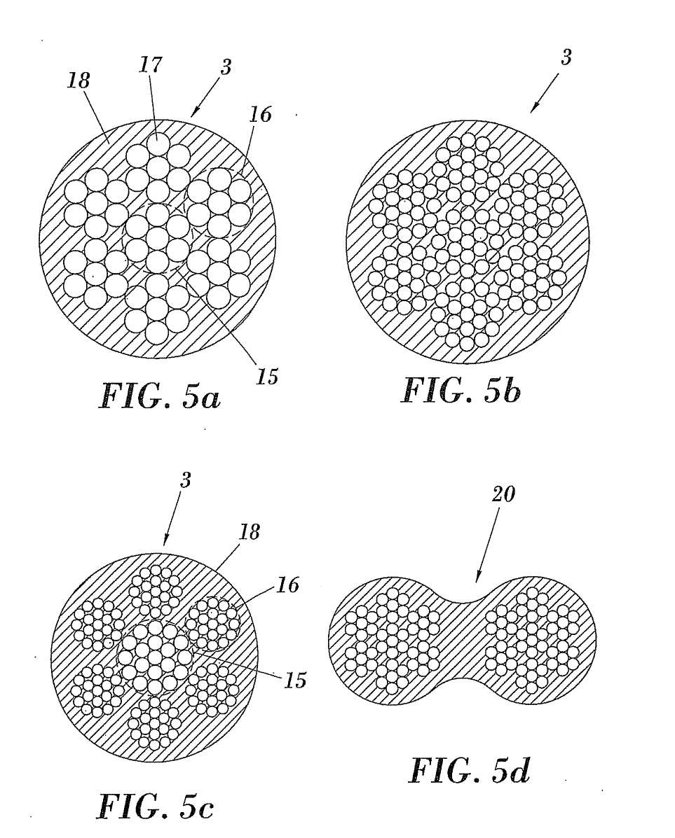

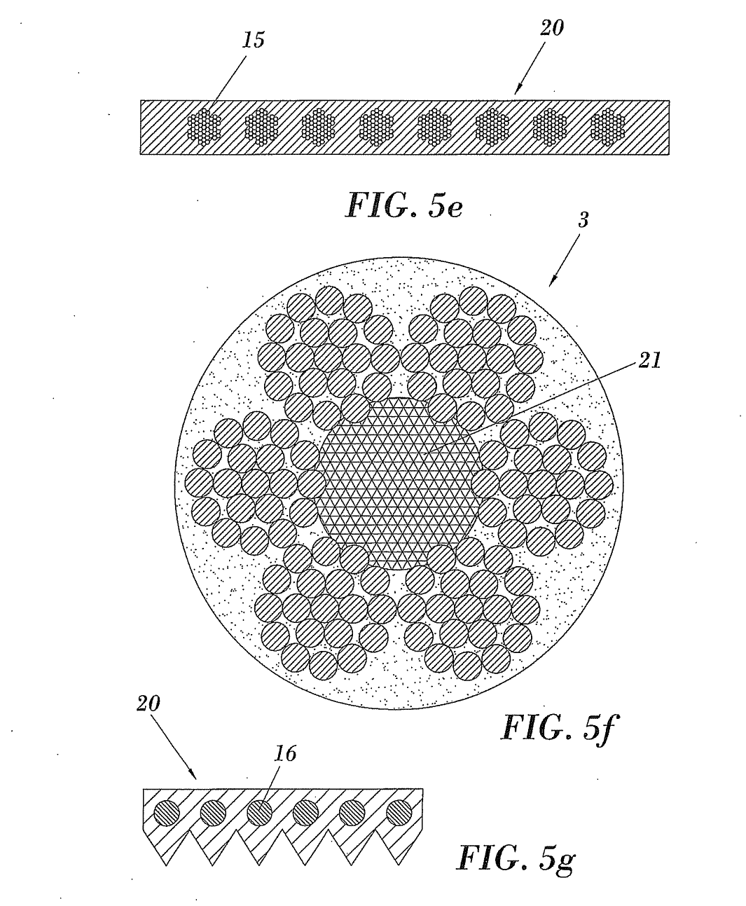

FIGS. 5a, 5b, 5c, 5d, 5e, 5f and 5g show an example of the coated ropes (3) and coated belts (20) used in the first part (2) of the suspension and traction element (1, 1′, 1″).

FIG. 5a shows a coated rope (3) formed by a core strand (15) on which 6 strands (16) are twisted, both the core strand (15) and the strands (16) being formed by 7 high mechanical strength steel wires (17). All the strands (15, 16) are coated with thermoplastic material covering (18).

The coated rope (3) shown in FIG. 5b is similar to the previous one except in that the number of wires (17) forming each strand (15, 16) is 19 wires.

FIG. 5c shows another example of coated rope (3) which is different from the previous ones in that the wires (17) forming it do not have the same diameter, such that the core strand (15) has a greater diameter than the strands (16), allowing the covering (18) to penetrate between the strands (16).

FIG. 5d shows a belt (20) or so-called “bone” type rope consisting of two individual ropes the outer covering of which makes one integral with one another, providing the resulting assembly with a larger surface of contact with the groove of the traction sheave (10), therefore increasing the grip and the traction capacity of the system.

FIG. 5e also shows a flat belt (20) which is obtained by the coating of 8 sets of strands (16).

FIG. 5f shows a coated rope (3), similar to that of FIG. 5b, in which the core strand (15) has been replaced by a core (21) of synthetic material, such as propylene.

FIG. 5g shows a shaped belt (20) having longitudinal ribs of different geometries, for example triangular and/or trapezoidal, which are obtained by the coating of 6 sets of strands (16).

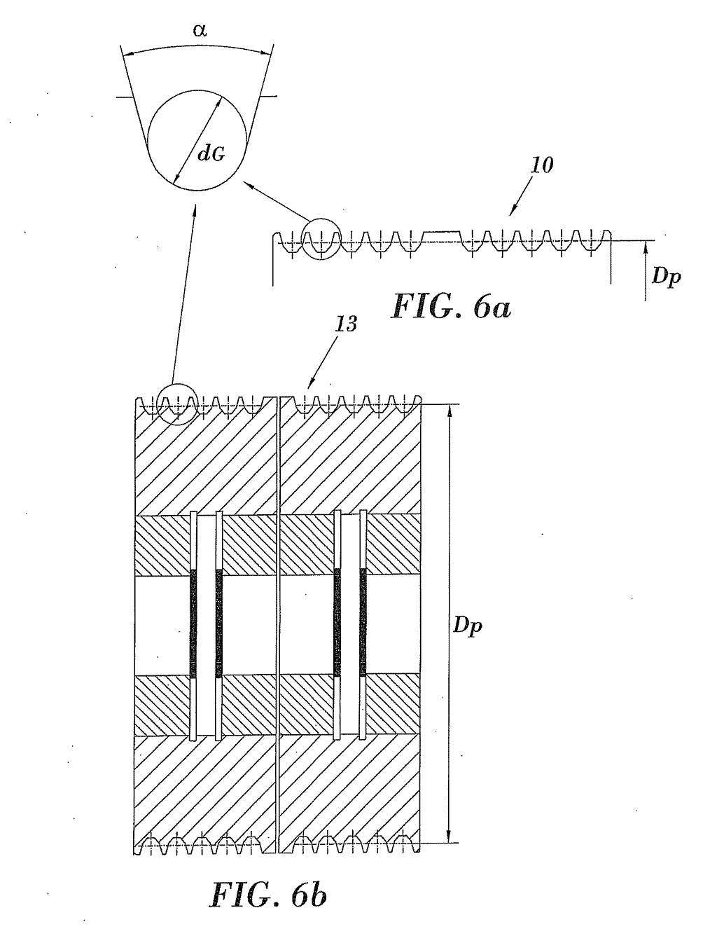

FIG. 6a shows the shape of the grooves of a traction sheave (10) of the elevator apparatus adapted for two suspension and traction elements (1, 1′, 1″) according to the invention, the first part (2) of each of which is formed by 5 individual ropes. The grooves coincide in number with the number of ropes, are semicircular and the pitch diameter thereof is preferably less than 150 mm; however, they can also adopt any other geometry, such as for example notched semicircular grooves, V-grooves, etc . . .

FIG. 6b shows a guide sheave (13) for elevator apparatuses adapted for two suspension and traction elements (1, 1′, 1″) according to the invention, which is provided with two groups of grooves clustered in respective freely rotating and independent discs, in which the grooves have a pitch diameter preferably equal to or less than 150 mm and are clustered in one and the same disc coinciding in number with the number of coated ropes (3) of the first part (2) of the suspension and traction element (1, 1′, 1″).

Detail A shows the diameter of the groove d_{G} of the traction (10) or guide (13) sheaves and the angle α of the geometric profile of each groove.

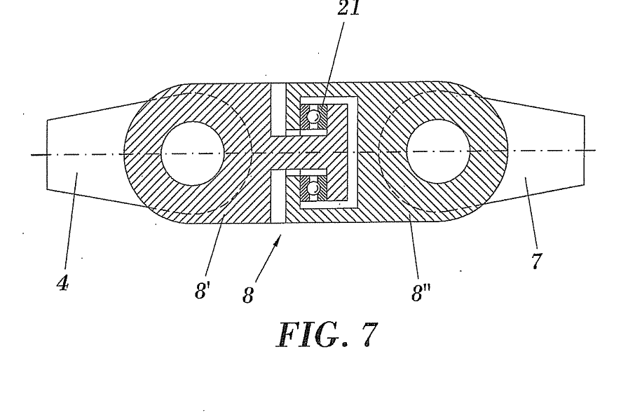

FIG. 7 shows a possible embodiment of the intermediate part (8) formed by two sectors (8′, 8″), each of which is associated to the connecting part (4) of the first part (2) and to the rope fastenings (7) of the second part (5), respectively, one of the sectors (8′) being assembled on a track of an axial bearing (21) and the other sector (8″) on another track of the same bearing (21) to facilitate the relative rotation thereof and therefore the rotation of the first part (2) with respect to the second part (5) about the longitudinal axis of the suspension and traction element (1, 1′, 1″).

1. Suspension and traction element for elevator apparatuses incorporating a traction sheave, a car and a counterweight and optionally deflector sheaves of car and counterweight respectively, comprising:
a first part formed by at least one coated rope or at least one coated belt, covered with thermoplastic material, forming a contact and/or a traction sector on the traction sheave and on the deflector sheaves, and by connecting parts on which ends of the coated ropes or coated belts are fixed and clustered,
at least one second part associated to at least one of the connecting parts consisting of an elongated element forming a support sector which does not contact the traction sheave or the deflector sheaves.

2. Suspension and traction element for elevator apparatuses according to claim 1, wherein the second part consists of a single rope and respective rope fastenings located at the rope's ends.

3. Suspension and traction element for elevator apparatuses according to claim 1, wherein the element further comprises at least one intermediate part connecting the first part with the second part.

4. Suspension and traction element for elevator apparatuses according to claim 3, wherein the intermediate part is provided with rotation means allowing an axial rotation of the first part with respect to the second part.

5. Suspension and traction element for elevator apparatuses according to claim 4, wherein the rotation means consist of an axial bearing associated on one side to a sector of the intermediate part connected to the connecting part of the first part and associated on the other side to another sector of the intermediate part connected to a rope fastening of the second part.

6. Suspension and traction element for elevator apparatuses according to claim 1, wherein the coated ropes have connecting rope fastenings at their ends which are connected to respective connecting parts, which are directly secured to the second part.

7. Suspension and traction element for elevator apparatuses according to claim 1, wherein the coated rope is formed by steel wires with strength ≧2000 N/mm² clustered in strands which are twisted to form a set with diameter d≦5 mm, having an outer coating of thermoplastic or elastomeric material partially penetrating between the strands and providing a slightly thick outer layer.

8. Suspension and traction element for elevator apparatuses according to claim 1, wherein the coated belt is formed by steel wires with strength ≧2000 N/mm² clustered in strands separated a constant distance in their length and coated with thermoplastic or elastomeric material.

9. Suspension and traction element for elevator apparatuses according to claim 1, wherein the coated ropes are formed by synthetic fibers, preferably aramid or Kevlar clustered together, forming at least one strand coated with thermoplastic or elastomeric material.

10. Elevator apparatus incorporating a traction sheave, a car and a counterweight and optionally deflector sheaves of car and counterweight, wherein the elevator apparatus comprises a suspension element described in claim 1.

11. Elevator apparatus according to claim 10, wherein the traction sheave is provided with groups of grooves with pitch diameter D_{P}≦150 mm coinciding in number with a number of coated ropes of the first part of each suspension and traction element.

12. Elevator apparatus according to claim 11, wherein the grooves are preferably semicircular, a geometry of which has a diameter d_{G} meeting the following:
d≦d_{G}≦1.5d
where d is a diameter of the coated rope and d_{G} a diameter of the geometric profile of each groove of the traction sheave and
10°≦α≦75°
where α is an angle of a geometric profile of each groove of the traction sheave.

13. Elevator apparatus according to claim 12, wherein 1.05 d≦d_{G}≦1.3 d and 25°≦α≦45°.

14. Elevator apparatus according to claim 10, wherein the guide sheaves are provided with groups of grooves coinciding in number with a number of suspension and traction elements which are clustered in respective freely rotating and independent discs with pitch diameter D_{P}≦150 mm, each of the groups of grooves being formed by a number of grooves coinciding with a number of coated ropes of the first part of the suspension and traction element.

15. Elevator apparatus according to claim 14, wherein the grooves are semicircular, a geometry of which has a diameter d_{G} meeting the following:
d≦d_{G}≦1.5d
where d is a diameter of the coated rope and d_{G} a diameter of a geometric profile of each groove of the guide sheave and
10°≦α≦75°
where α is an angle of a geometric profile of each groove of the sheave.

16. Elevator apparatus according to claim 15, wherein 1.05 d≦d_{G}≦1.3 d and 25°≦α≦45°.
